(19) United States
(12) Patent Application Publication
(10) Pub. No.: US 2006/0093903 A1
(43) Pub. Date: May 4, 2006

(54) Cylindrical lithium ion battery and method for manufacturing the same

(76) Inventors: Eui-Sun Hong, Youngin-si (KR); Yasuaki Hiramura, Youngin-si (KR); Masaki Koike, Youngin-si (KR)

Correspondence Address: Robert E. Bushnell, Suite 300, 1522 K Street, N.W., Washington, DC, 20005, US

(21) Appl. No.: 11/260,470

(22) Filed: Oct. 28, 2005

(30) Foreign Application Priority Data
Oct. 28, 2004 (KR) 10-2004-0086898

(51) Int. Cl. H01M 2/26; H01M 2/02; H01M 10/50; H01M 2/08

(52) U.S. Cl. 429/161; 429/164; 429/94; 429/62; 29/623.3; 29/623.2; 429/174

(57) ABSTRACT

A cylindrical lithium ion battery and a method of manufacturing the same. A center pin is easily inserted into a space within an electrode assembly to retain and support it on the interior of a cylindrical can. The cylindrical lithium ion battery includes an electrode assembly wound in a cylindrical shape with the space defined at the center thereof, a cylindrical can containing the electrode assembly and having an open top, a center pin located within the space of the electrode assembly and having a diameter which is small upon insertion and becomes larger after insertion to fill in the space, a cap assembly attached to the top of the cylindrical can to prevent the electrode assembly and the center pin from escaping the can.

### CLAIM OF PRIORITY

This application makes reference to, incorporates the same herein, and claims all benefits accruing under 35 U.S.C.§119 from an application for CYLINDRICAL LITHIUM ION BATTERY AND METHOD FOR MANUFACTURING THE SAME earlier filed in the Korean Intellectual Property Office on 28 Oct. 2004 and there duly assigned Serial No. 10-2004-0086898.

### BACKGROUND OF THE INVENTION

1. Field of the Invention

The present invention relates to a cylindrical lithium ion battery and a method of manufacturing the same, and more particularly to a cylindrical lithium ion battery having a center pin made of an elastic material or of a shape memory alloy and a method of manufacturing the same.

2. Description of the Related Art

In general, a cylindrical lithium ion battery includes an electrode assembly wound in an approximately cylindrical shape, a cylindrical can to which the electrode assembly is inserted into, an electrolyte injected into the can to enable lithium ions to move, and a cap assembly attached to a side of the can to prevent the electrolyte from leaking and to prevent the electrolyte assembly from escaping.

Cylindrical lithium ion batteries normally have a capacity of 2000-2400 mA and are commonly mounted in laptop computers, digital cameras, and camcorders, which consume a large amount of electric power. For example, a number of cylindrical lithium ion batteries are connected in series and in parallel as desired and assembled in a hard pack of a predetermined shape, while a protective circuit is mounted thereon, to be connected to electronic appliances and serve as their power supply.

Such a cylindrical lithium ion battery is manufactured as follows. A negative electrode plate having a predetermined active material formed thereon, a separator, and a positive electrode plate having a predetermined active material formed thereon are laminated together. An end of the laminate is attached to a rod-shaped winding shaft and the laminate is wound to have an approximately cylindrical shape to provide an electrode assembly. The electrode assembly is inserted into a cylindrical can and an electrolyte is injected therein. Finally, a cap assembly is welded to the top of the cylindrical can to complete the cylindrical lithium ion battery.

When the electrode assembly is separated from the winding shaft prior to insertion into the can, the winding shaft leaves behind a space at the center of the electrode assembly, which corresponds to its axis. Parts of the electrode assembly are pushed into the space during charging and discharging and, as a result, the electrode assembly deforms with time. In addition, the positive and negative electrode plates can also short-circuit together. In this case, the battery itself must be discarded. For this reason, a center pin having a rod-shape is inserted into the space in the electrode assembly to prevent the electrode assembly from deforming during charging and discharging.

As batteries tend to have higher capacity in line with current trends, the diameter of the winding shaft continuously decreases to allow for an increase in the number of windings of the electrode assembly. Consequently, poor insertion of the center pin occurs frequently, because the center pin must be inserted into an even smaller space. Specifically, the space defined at the center of the electrode assembly is too small to couple the center pin thereto easily. In addition, the center pin can damage the separator or the negative electrode plate during the difficult insertion process.

The problem of poor insertion can be solved to some degree by reducing the diameter of the center pin in accordance with that of the winding shaft. In this case, however, the strength of the center pin degrades and it can bend or break easily. Furthermore, the center pin within the electrode assembly and is acted on by a predetermined pressure from it, which can bend the center pin easily.

In addition, various external forces can act on the can of the battery. For example, a horizontal or vertical pressure can act on the can and, if the center pin has a poor strength, it could deform the can easily. Such deformation can results in a secondary short-circuit, fire, or explosion. Therefore, what is needed is a solution to the problem of preventing deformation of the electrode assembly when the space left behind from the winding shaft is small.

### SUMMARY OF THE INVENTION

It is therefore an object of the present invention to provide an improved design for a cylindrical lithium ion battery.

It is also an object of the present invention to provide a design for a cylindrical lithium ion battery that prevents deformation of the electrode assembly when the space left behind from the winding shaft is very small.

It is also an object of the present invention to provide in improved center pin for a cylindrical lithium ion battery.

It is further an object of the present invention to provide a method of making the improved cylindrical lithium ion battery.

It is still an object of the present invention is to provide a cylindrical lithium ion battery having a center pin adapted to be easily inserted to an electrode assembly and a method of manufacturing the same.

These and other objects can be achieved by a cylindrical lithium ion battery that includes a cylindrical can having an open top, the can includes an electrode assembly, the electrode assembly being wound in a cylindrical shape and having a space defined at the center thereof, a center pin arranged within the space of the electrode assembly and forced against the electrode assembly by an elastic force acting outwards towards the electrode assembly, and a cap assembly attached to the top of the cylindrical can.

The center pin can include an elastic body adapted to expand outwards towards the cylindrical can and fill or entirely occupy the space when arranged within the space of the electrode assembly. Alternatively, the center pin can include shape memory alloy, the center pin expanding to fill the space with certain temperature changes

In accordance with another aspect of the present invention, there is provided a method of manufacturing a cylindrical lithium ion battery, including laminating together a positive electrode plate, a separator, and a negative electrode plate to form a laminate, attaching a winding shaft to an end of the laminate, winding the laminate in an approximately cylindrical shape to form an electrode assembly, attaching the electrode assembly to a cylindrical can, separating a winding shaft from the electrode assembly, inserting a center pin into a space within the electrode assembly, the space being defined by the separating of the winding shaft, allowing the center pin to expand and fill the space after the inserting and attaching a cap assembly to a top of the cylindrical can.

The cylindrical lithium ion battery and method of manufacturing the same according to the present invention are advantageous in that the diameter of the center pin is smaller than that of the space defined in the electrode assembly before or while the center pin is being inserted into the electrode assembly and increases after insertion to fill the space so that the center pin can be easily inserted and the electrode assembly is prevented from deforming. As the electrode assembly is firmly retained by the center pin, the electrode assembly does not change its shape during charging and discharging and the cylindrical can and the center pin are not easily broken, even when the cylindrical can is subjected to horizontal or vertical compression.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1A is a perspective view of a cylindrical lithium ion battery according to the present invention;

FIG. 1B is a sectional view taken along line 1B-1B of FIG. 1A;

FIG. 1C is a sectional view taken along line 1C-1C of FIG. 1A;

FIG. 2A is a sectional view a center pin of elastic material upon insertion into a space within an electrode assembly of a cylindrical lithium ion battery according to an embodiment of the present;

FIG. 2B is a sectional view of the center pin of FIG. 2A after the center pin has expanded to fill the space;

FIG. 3A is a sectional view of a center pin of shape memory alloy upon insertion into a space within an electrode assembly of a cylindrical lithium ion battery according to another embodiment of the present invention;

FIG. 3B is a sectional view of the center pin of FIG. 3A after the center pin has been restored to its original shape filling the space;

FIG. 4 is a flowchart showing a series of steps in a method of manufacturing a cylindrical lithium ion battery according to the embodiments of the present invention; and

FIGS. 5A to 5E are diagrammatic views showing the respective steps of FIG. 4.

### DETAILED DESCRIPTION OF THE INVENTION

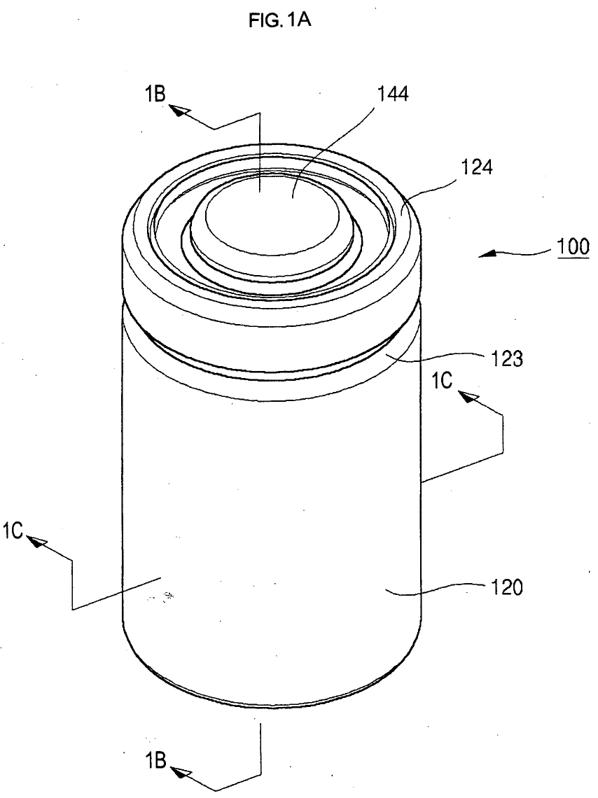

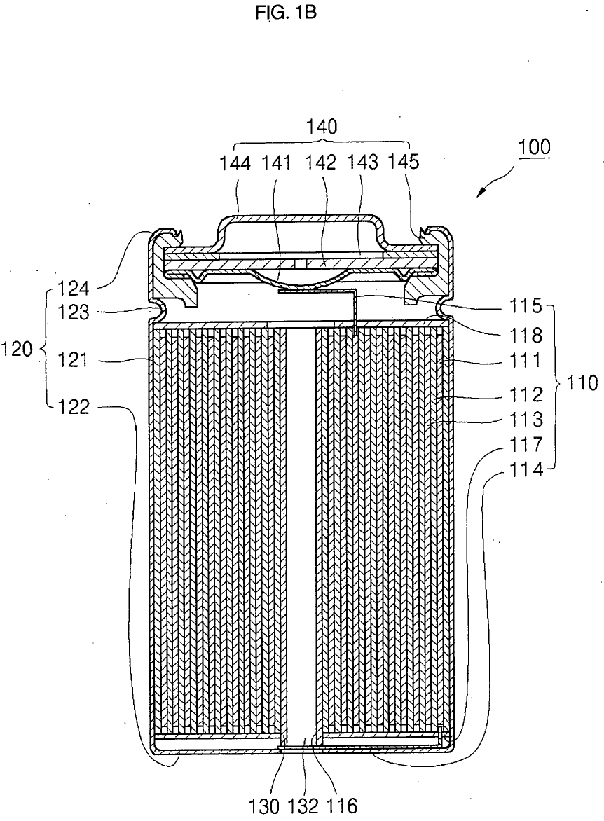

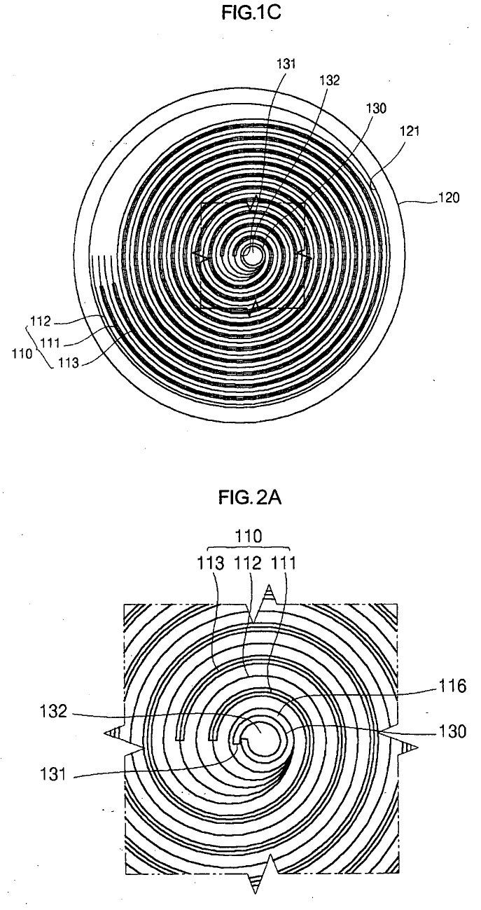

Turning now to FIGS. 1A through 1C, FIG. 1A is a perspective view showing a cylindrical lithium ion battery 100 according to the present invention, FIG. 1B is a sectional view taken along line 1B-1B of FIG. 1A, and FIG. 1C is a sectional view taken along line 1C-1C of FIG. 1A. As shown in FIGS. 1A through 1C, a cylindrical lithium ion battery 100 according to the present invention includes an electrode assembly 110, a cylindrical can 120, a center pin 130, and a cap assembly 140.

The electrode assembly 110 includes a negative electrode plate 111 having negative electrode active material (not shown), such as graphite attached thereto, a positive electrode plate 113 having positive electrode active material (not shown), such as lithium cobalt oxide (LiCoO₂) attached thereto, and a separator 112 positioned between the negative and positive electrode plates 111 and 113 to prevent a short circuit and to allow only lithium ions to move. The negative and positive electrode plates 111 and 113 and the separator 112 are wound into the shape of an approximately circular post and are placed into the cylindrical can 120. The negative electrode plate 111 can be made of copper (Cu) foil, the positive electrode plate 113 can be made of aluminum (Al) foil, and the separator 112 can be made of polyethylene (PE) or polypropylene (PP), but the material is not limited to that in the present invention.

The negative electrode plate 111 can have a negative electrode tab 114 welded thereto while protruding downwards a predetermined length. The positive electrode plate 113 can have a positive electrode tab 115 welded thereto while protruding upwards a predetermined length. The negative and positive electrode tabs 114 and 115 can be made of nickel (Ni) and aluminum (Al), respectively, but the material is not limited to that in the present invention.

The can 120 of an approximately cylindrical shape includes a cylindrical surface 121 having a predetermined diameter and a bottom surface 122 of an approximately disk shape positioned on the lower portion of the cylindrical surface 121. The upper portion of the cylindrical surface 121 is open so that the electrode assembly 110 can be inserted downwards into the cylindrical can 120 via its top. The negative electrode tab 114 of the electrode assembly 110 is welded to the bottom surface 122 of the cylindrical can 120, which then acts as a negative electrode. The electrode assembly 110 has lower and upper insulation plates 117 and 118 attached to the lower and upper portions thereof, respectively, to avoid any unnecessary short circuit between the electrode assembly 110 and the cylindrical can 120. The cylindrical can 120 can be made of steel, stainless steel, aluminum, or an equivalent thereof, but the material is not limited to that herein.

A center pin 130 is inserted into a space 116 defined approximately at the center of the electrode assembly 110. The center pin 130 is of an approximately rod shape and has a hollow portion 132 formed therein and a cutout groove 131 formed in the longitudinal direction. Ends of the cutout groove 131 can be fastened to each other when the center pin 130 is inserted to the electrode assembly 110. Alternatively, ends of the cutout groove 131 can remain spaced a predetermined distance from or superimposed on each other.

The center pin 130 spans about 90-110% of the overall height of the electrode assembly 110 with its lower end positioned on the negative electrode tab 114. If the height of the center pin 130 is smaller than 90% of that of the electrode assembly 110, retention and support of the electrode assembly 110 is insufficient, and if larger than 110%, the center pin 130 can undesirably contact a component of the cap assembly 140 (described later).

The cap assembly 140 has an insulating gasket 145 of an approximately ring shape attached to the top of the cylindrical can 120 and a conductive safety vent 141 attached to the insulating gasket 145 while being attached to the positive electrode tab 115. The conductive safety vent 141 is adapted to fracture when the internal pressure of the can 120 rises so that gas from the cylindrical can 120 can expel to the exterior. The conductive safety vent 141 has a current interruption plate 142 formed on the upper portion thereof that fractures together when the conductive safety vent 141 fractures to interrupt the current. A positive thermal coefficient (PTC) device 143 connected to the upper portion of the current interruption plate 142 to interrupt upon excessive current. In addition, a conductive positive electrode cap 144 is connected to the upper portion of the PTC device 143 to provide positive voltage to the exterior of cylindrical can 120. The current interruption plate 142, the PTC device 143, and the positive electrode cap 144 are mounted inside the insulating gasket 145.

The cylindrical can 120 has a beading part 123 positioned on the lower portion of the cap 8 assembly 140, while being recessed towards the interior, and a crimping part 124 formed on the upper portion of the cap assembly 140, while being bent towards the interior, in order to prevent the cap assembly 140 from separating from cylindrical can 120. The beading and crimping parts 123 and 124 retain and support the cap assembly 140 together to the cylindrical can 120.

The cylindrical can 120 has an electrolyte (not shown) injected therein to enable lithium ions to move, which are created by an electrochemical reaction at the negative and positive electrode plates 111 and 113 inside the battery 100 during charging and discharging. The electrolyte can be a non-aqueous organic electrolyte, which is a mixture of lithium salt and a high-purity organic solvent. In addition, the electrolyte can be a polymer using a high-molecular electrolyte, but the type of the electrolyte is not limited to that herein.

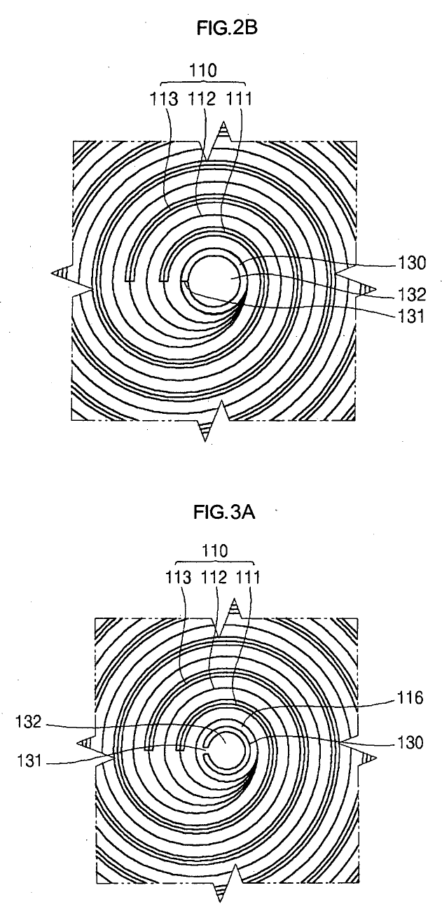

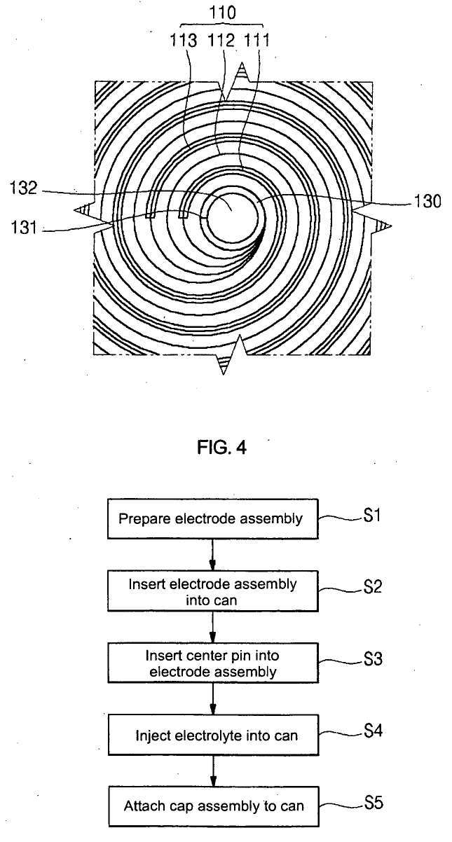

Turning now to FIGS. 2A and 2B, FIG. 2A is a sectional view showing a center pin 130 of a cylindrical lithium ion battery according to an embodiment of the present invention, where the center pin is made out of an elastic material and is inserted into a space 116 within electrode assembly 100, and FIG. 2B is a sectional view of the elastic material center pin 130 of FIG. 2A after the center pin 130 has been restored to its original shape after insertion.

When the center pin 130 is made out of an elastic material, as mentioned above, its diameter or size can be reduced to some degree by an external force. For example, an end of the center pin 130 is positioned to the inner side of the cutout groove 131, as in FIG. 2A. The groove 131 is formed in the longitudinal direction, and the other end is deformed towards the outer side thereof to further reduce the diameter of the hollow portion 132, as shown in FIG. 2A. Therefore, the center pin 130 can be inserted into the electrode assembly 110 while being reduced to have a diameter or size smaller than the space 116 defined in the electrode assembly 110. Such reduction in diameter also makes it possible to easily insert the center pin 130 into the space 116 without interfering with the separator 112, the negative electrode 111, or the positive electrode 113 of the electrode assembly 110.

After the insertion process, the external force is removed from the center pin 130 and the center pin 130 is then restored to its original shape as in FIG. 2B. This means that the center pin 130 pushes the electrode assembly 110, particularly the separator 112 and the negative and positive electrode plates 111 and 113, in an outward direction towards interior surface 121 of cylindrical can 120. As a result, the electrode assembly 110 is firmly retained and supported between the center pin 130 and the cylindrical can 120.

As the electrode assembly 110 is firmly retained and supported between the center pin 130 and the cylindrical surface 121 of the cylindrical can 120 in this manner, the electrode assembly 110 is prevented from being deforming during charging and discharging and the cylindrical can 120 is better able to endure horizontal or vertical compression, which can act on the outer portion thereof.

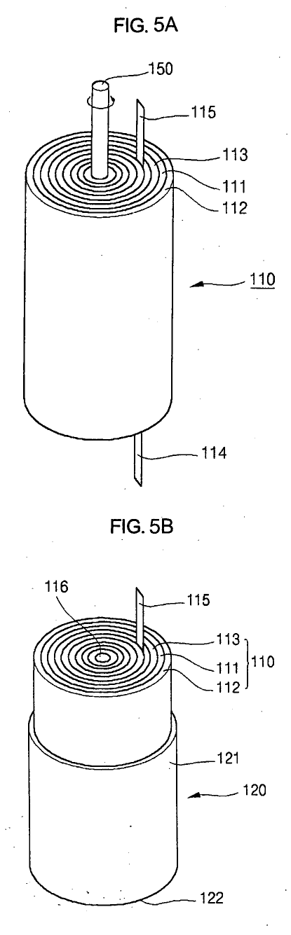

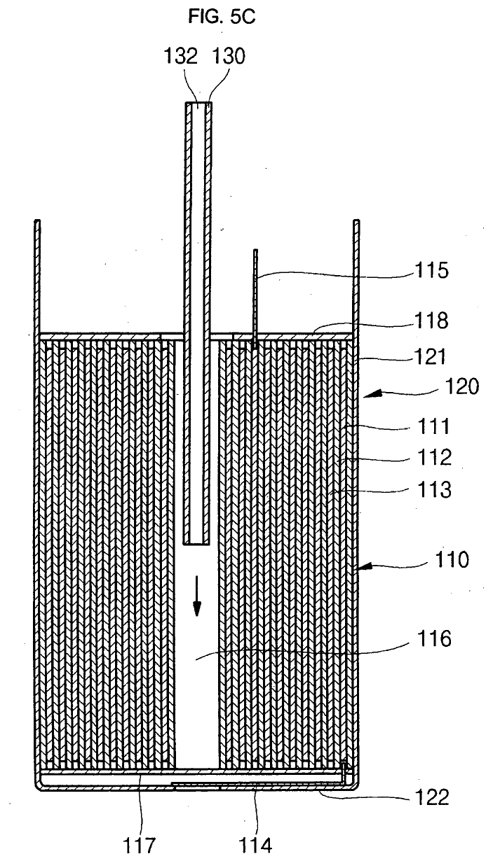

Turning now to FIGS. 3A and 3B, FIG. 3A is a sectional view showing a center pin 130, made of a shape memory alloy, in a compressed state and within space 116 within an electrode assembly 110 of a cylindrical lithium ion battery according to another embodiment of the present invention, and FIG. 3B is a sectional view of the center pin 130 of FIG. 3A after the center pin has been restored to its original shape and size after insertion.

As mentioned above, the center pin 130 can be made of a shape memory alloy, the diameter or size of which can decrease to some degree at a predetermined temperature. For example, the diameter can have the maximum value at a normal temperature and decrease outside the normal temperature (i.e., at a lower or higher temperature). The center pin 130 can be made of any one of a Fe-based material, a Cu-based material, a TiNi-base material, and an equivalent thereof, but the material is not limited to that herein as long as the diameter has the maximum value at a normal temperature and decreases at a lower or higher temperatures, as mentioned above.

Before and during when the center pin 130 made of a shape memory alloy is inserted into to the electrode assembly 110, the temperature of the center pin 130 is either lowered below or raised above the normal temperature so that its diameter or size is smaller than that of the space 116 defined in the electrode assembly 110. Such reduction in diameter of the center pin 130 makes it possible to easily insert the center pin 130 into the space 116 without interfering the separator 112, the negative electrode 111, or the positive electrode 113 of the electrode assembly 110.

After the insertion process, the center pin 130 is allowed to return to the normal temperature condition so that the center pin can be restored to its original shape. This means that the center pin 130 fills space 116 and then pushes the electrode assembly 110, particularly the separator 112 and the negative and positive electrode plates 111 and 113 outwards towards cylindrical can 120. As a result, the electrode assembly 110 is firmly retained and supported between the center pin 130 and the cylindrical surface 121 of the cylindrical can 120.

As the electrode assembly 110 is firmly retained and supported between the center pin 130 and the cylindrical surface 121 of the cylindrical can 120 in this manner, the electrode assembly 110 is prevented from being deforming during charging and discharging and the cylindrical can 120 is better able to endure horizontal and vertical compression, which can act on the outer portion thereof.

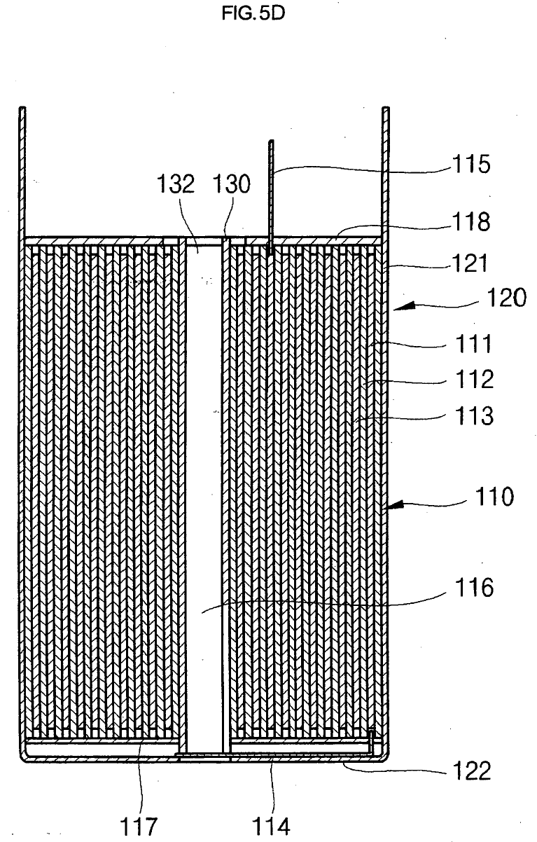

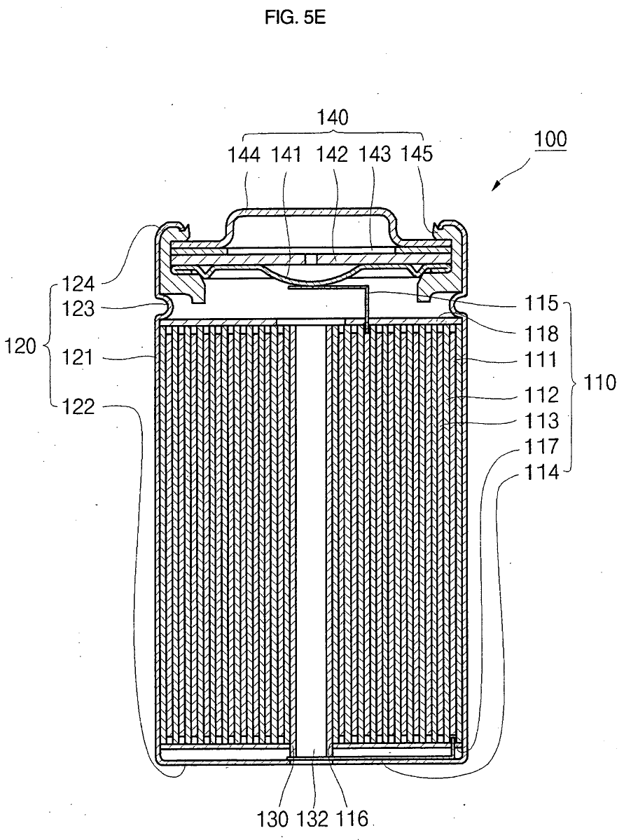

Turning now to FIGS. 4 and 5A through 5E, FIG. 4 is a flowchart showing a series of steps in a method of manufacturing a cylindrical lithium ion battery according to the present invention and FIGS. 5A to 5E are diagrammatic views corresponding to the respective steps of FIG. 4. Reference will now be made to FIGS. 4 and 5A to 5E simultaneously to describe the method.

As illustrated in FIG. 4, a method of manufacturing a cylindrical lithium ion battery 100 according to the present invention includes forming or assembling the electrode assembly 110 (step S1 and FIG. 5A), inserting the electrode assembly 110 into the cylindrical can 120 (step S2 and FIG. 5B), inserting the center pin 130 into the electrode assembly 110 (step S3 and FIG. 5C), injecting an electrolyte into the cylindrical can 120 (step S4 and FIG. 5D), and attaching a cap assembly 140 to the cylindrical can 120 (step S5 and FIG. 5E).

During formation of the electrode assembly 110 of step S1 and FIG. 5A, a negative electrode plate 111, a separator 112, and a positive electrode plate 113 are successively laminated. An end of the laminate is attached to a winding shaft 150 and is wound in an approximately cylindrical shape about winding shaft 150 to form the electrode assembly 110. Negative and positive electrode tabs 114 and 115 are connected to the negative and positive electrode plates 111 and 113, respectively, before the winding.

In step S2 and FIG. 5B, the cylindrical electrode assembly 110 is inserted into cylindrical can 120. After the insertion, the electrode assembly 110 is separated from the winding shaft 150 to produce circular space 116 at the center of the electrode assembly 110. Alternatively, the winding shaft 150 can be previously separated before insertion of the electrode assembly 110 into cylindrical can 120, and the order of processes is not limited to that herein. The cylindrical can 120 has a lower insulation plate (not shown) previously attached thereto.

In step S3 and FIG. 5C, a center pin 130, the diameter of which increases after insertion, is inserted into the space 116 of the electrode assembly 110 after separating the winding shaft 150 from the electrode assembly 110. Specifically, the center pin 130 is made out of either an elastic material or a shape memory alloy. In its reduced size state, center pin 130 has a diameter smaller than that of the space 116 defined in the electrode assembly 110 before and during insertion. The diameter of the center pin 130 increases up to the diameter of the space 116 defined in the electrode assembly 110 after insertion by means of an elastic force, a restoration force, or a shape memory function. As a result, the center pin 130 strongly pushes the electrode assembly 110 against the cylindrical surface 121 of the cylindrical can 120 to firmly retain and support the electrode assembly 110 inside the cylindrical can 120.

Before insertion of the center pin 130, the negative electrode tab 114 connected to the negative electrode plate 111 of the electrode assembly 110 can be connected to the bottom surface 122 of the cylindrical can 120 by, for example, resistance welding. In this case, the center pin 130 keeps in contact with the upper surface of the negative electrode tab 114 and couples the negative electrode tab 114 to the cylindrical can 120 more strongly. As mentioned above, the center pin 130 preferably spans about 90-110% of the height of the electrode assembly 110. If the height of the center pin 130 is smaller than 90% of that of the electrode assembly 110, retention and support of the electrode assembly 110 is insufficient, and if larger than 110%, the center pin 130 can undesirably contact a component of the cap assembly 140 (described later).

During the electrolyte injection step S4 and in FIG. 5D, an electrolyte (not shown) is injected into cylindrical can 120 approximately up to the top of the electrode assembly 110. The electrolyte enables lithium ions to move between the negative and positive electrode plates 111 and 113 of the electrode assembly 110 during charging and discharging as mentioned above.

During the attachment of cap assembly 140 to cylindrical can 120 in step S5 and in FIG. 5E, a cap assembly 140 including a number of components is attached to the top of the cylindrical can 120 to prevent the electrode assembly 110, the center pin 130 and the electrolyte from escaping or leaking out. Specifically, an insulating gasket 145 having a ring shape is attached to the top of the cylindrical can 120 and a conductive safety vent 141, a current interruption plate 142, a PTC device 143, and a positive electrode cap 144 are successively connected therein to be connected to the positive electrode tab 115 of the electrode assembly 110. A part of the cylindrical can 120 corresponding to the bottom of the insulating gasket 145 is subjected to beading to form a beading part 123, while being recessed towards the interior, and the top thereof is subjected to crimping to form a crimping part 124, in order to prevent the cap assembly 140 from being separated from cylindrical can 120. As a result, a cylindrical lithium ion battery 100 according to the present invention is completed.

As mentioned above, the cylindrical lithium ion battery and method of manufacturing the same according to the present invention are advantageous in that the diameter of the center pin is smaller than that of the space defined within the electrode assembly before or while the center pin is inserted into the space within the electrode assembly. The diameter of the center pin is then allowed to increase after insertion so that the center pin can be pressed against the electrode assembly so that deformation of the electrode assembly is prevented. As the electrode assembly is firmly retained by the center pin, the electrode assembly will not change its shape during charging and discharging. Further, the cylindrical can and the center pin are not easily broken, even when the cylindrical can is subjected to horizontal or vertical compression.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A cylindrical lithium ion battery, comprising:
a cylindrical can having an open top, the can comprising an electrode assembly, the electrode assembly being wound in a cylindrical shape and having a space defined at the center thereof;
a center pin arranged within the space of the electrode assembly and forced against the electrode assembly by a force acting outwards towards the electrode assembly; and
a cap assembly attached to the top of the cylindrical can.

2. The battery of claim 1, wherein the center pin has a shape of a rod and comprises a cutout groove extending in a longitudinal direction, ends of which are fastened to each other, spaced a predetermined distance from each other, or superimposed on each other.

3. The battery of claim 1, wherein the center pin comprises an elastic body adapted to expand outwards towards the cylindrical can and entirely occupy the space when arranged within the space of the electrode assembly.

4. The battery of claim 1, wherein the center pin comprises shape memory alloy, the center pin expands to entirely occupy the space upon certain temperature changes.

5. The battery of claim 1, wherein the center pin comprises a material selected from the group consisting of an Fe-based material, a Cu-based material and a TiNi-based shape memory alloy, a diameter of the center pin increases at a predetermined temperature.

6. The battery of claim 1, wherein the center pin has a length of 90% to 110% of a height of the electrode assembly.

7. The battery of claim 1, wherein the electrode assembly comprises:
a positive electrode plate;
a negative electrode plate;
a separator arranged between the positive electrode plate and the negative electrode plate;
a positive electrode tab connected to the positive electrode plate while also being connected to the cap assembly; and
a negative electrode tab connected to the negative electrode plate while also being connected to a bottom surface of the cylindrical can, the center pin being arranged on the negative electrode tab.

8. The battery of claim 7, wherein the cap assembly comprises:
a ring shaped insulation gasket attached to the top of the cylindrical can;
a conductive safety vent attached to an inner lower end of the insulation gasket while also being attached to the positive electrode tab, the conductive safety vent being adapted to fracture when an internal pressure of the can rises allowing gas from inside the can to escape;
a current interruption plate arranged on top of the conductive safety vent and adapted to break when the conductive safety vent is actuated so that current is interrupted;
a positive temperature coefficient (PTC) device adapted to interrupt excessive current and arranged on top of the current interruption plate; and
a conductive positive electrode cap adapted to provide positive voltage to an exterior of the cylindrical can and arranged on top of the PTC device.

9. The battery of claim 1, further comprising:
a lower insulation plate arranged between the electrode assembly and a bottom surface of the cylindrical can; and
an upper insulation plate arranged between the electrode assembly and the cap assembly.

10. A method of manufacturing a cylindrical lithium ion battery, comprising:
laminating together a positive electrode plate, a separator and a negative electrode plate to form a laminate;
attaching a winding shaft to an end of the laminate;
winding the laminate to a cylindrical shape to form an electrode assembly;
inserting the electrode assembly into a cylindrical can;
separating the winding shaft from the electrode assembly;
inserting a center pin into a space within the electrode assembly, the space being defined by the separating of the winding shaft;
allowing the center pin to expand and entirely occupy the space after the inserting; and
attaching a cap assembly to a top of the cylindrical can.

11. The method of claim 10, wherein the center pin is rod-shaped, the center pin comprises a cutout groove extending in a longitudinal direction with a predetermined width during the inserting, ends of which are fastened to each other, spaced a predetermined distance from each other, or superimposed on each other after the inserting of the center pin.

12. The method of claim 10, wherein the center pin comprises an elastic body that is adapted to expand outwards towards the cylindrical can after the inserting.

13. The method of claim 10, wherein the center pin comprises a shape memory alloy that is adapted to expand outwards when a temperature thereof increases.

14. The method of claim 10, wherein the center pin is adapted to expand when a temperature of the center pin increases, the center pin comprising a material selected from the group consisting of an Fe-based material, a Cu-based material and a TiNi-based shape memory alloy.

15. The method of claim 10, wherein the center pin expands to fill the space upon application of heat.

16. The method of claim 10, further comprising removing an external force compressing the center pin so that the compressed center pin expands outwards after the inserting.
